(19) United States
(12) Patent Application Publication
(10) Pub. No.: US 2007/0256126 A1
(43) Pub. Date: Nov. 1, 2007

(54) Secure identification remote and dongle

(75) Inventors: Craig Erickson, Stevenson Ranch, CA (US); Stephen Mitchell, Linton (GB)

Correspondence Address: RICHARD B. CATES, 2629 MANHATTAN AVE, PMB-273, HERMOSA BEACH, CA, 90254, US

(73) Assignee: EWAN1, Inc.

(21) Appl. No.: 11/404,299

(22) Filed: Apr. 14, 2006

(51) Int. Cl. H04L 9/32

(52) U.S. Cl. 726/20

(57) ABSTRACT

The invention is a method, system, and apparatus providing access to media content via an internet-like connection, such as television programming, games. A paired remote control and dongle can connected via an intermediary computer and the internet to a remote director. The dongle contains an access code, which may include an identification code and/or password. In response to receiving the access code from the dongle, the remote director provides the dongle and/or intermediary computer with access to the requested media content. The dongle may provide the access code only in response to an appropriate query. The appropriate query may be provided by the remote director and/or intermediary computer.

### FIELD OF THE INVENTION

The present invention relates to accessing streaming data via secure encryption and unique identification packets, and more particularly to an operational pairing of a remote control and dongle having their own unique identity and encryption.

### BACKGROUND

Software that allows the decryption and playing of subscribed video and audio streaming content as well as internet game content has been developed by those that are skilled in the art. Typically, a subscriber or user is required to enter or create a name and password to create an account, and this name and password combination allows the user to access the subscribed content.

It is often undesirable to require the user to enter this information (i.e., name and password) each time the user wishes to access the subscribed content. The repeated entry of such information can be time consuming, particularly where access is repeatedly sought. Additionally, the name and password are often lost or forgotten, requiring a secondary validation system by the provider that allows the user to retrieve the missing information on the very account that the user had created.

Therefore, it is desirable to provide a remote accessory and control device that is capable of automatically identifying each individual user and not requiring the repetitive input of this user data or requiring the placement of cookies on the individual system(s).

### SUMMARY

The invention is a wireless remote control system and software that reads, encrypts, and stores the unique data key identifying that individual subscriber. In this embodiment the process is transparent to the user, and the operational pair (the remote control unit and the receiving unit) contains the hidden and private key(s) that identifies the user. This key is used to encrypt the commands from the remote to keep the process secure and specific only to that particular individual user. This eliminates the need for the repeated entering of user names and passwords, while making the entire process more secure as well as transparent to the user. This system may also be used (in conjunction with encryption and/or decryption methods such as standard AES, DES encryption standards and certification certificates) to decrypt the multimedia streams directly from within the dongle, thus keeping the entire decryption process secure. The particular security and/or encryption algorithms used with the invention can be selected from those currently available in the industry, and/or could include newly-developed algorithms, etc., depending on the particular application.

A wireless remote control for executing software on a processor such as a personal computer (PC) manipulates and keeps secure the individual user's account identification, and identifies itself with secure encryption and unique ID packets while the software is accessing streaming data, such as IPTV (Internet Protocol Television) streams, online gaming, or other provided content via internet protocols (IP). Each operational pair (remote and dongle) have their own unique ID and encryption coding to identify each user as unique. The PC software interface is designed to identify the ID for that individual user. The dongle and remote pair can be operated on one personal computer system, or the operational pair (dongle and remote) can allow mobility and can easily be moved from one system to another, but still operating only with the specific unique ID and encryption assigned to that user. The invention thus allows for mobile viewing and content appreciation on different personal computer systems that have the complementary PC software installed on them.

In embodiments of the present invention, a linked control pair (comprising at least one wireless remote control and dongle) includes one or more controls for controlling streaming data and/or game content with complimentary software running on a personal computer (PC) and in direct conjunction and communication with the linked control pair.

The dongle contains the communication link, such as a wireless communication link, which may use infrared and/or radio-frequency transmissions, for communication with the remote control. The dongle also includes the private key and encryption algorithms, etc., and handshaking with the complimentary PC software that links with the media player or game content that comes from the subscriber site.

Depending on the particular embodiment, the remote control accessory will have its own power source, such as a standard or rechargeable battery. The dongle can contain the wireless communication chipset, a processor (such as an MPU that reads its own internal private encryption key and encodes communications with the PC, set-top box, or mobile device software as required for approval and ID verification, and that may have the ability to perform real-time encryption and/or decryption of the multimedia stream from within the dongle), and a communications device such as a USB communications chipset that allows the dongle to communicate with an intermediary PC, which may be a set-top box, cell phone, personal computer, or similar device having an appropriate interface (such as a USB interface) for interacting with the dongle.

The dongle includes an identification code and/or password, which is held in some sort of memory within the dongle. The identification and/or password memory can be incorporated into the dongle processor, and may be a flash ram storage. The identification and/or password may be pre-programmed into the dongle identification and/or password memory at the time of manufacture, and may be permanent and unchangeable after it is programmed. The identification and/or password may be changeable/writeable in response to operations of the remote control and/or director, etc. In one embodiment, the identification is held in a permanent, non-changeable memory, while the password is held in a changeable/writeable memory.

In an embodiment of the present invention, a portable remote and paired dongle are used and monitored by the accompanying software, so that when the user issues commands to control or access the content, that individual user is identified and allowed access to the content to which he or she has subscribed.

The remote and dongle can be part of a system according to the invention for accessing streaming data via the internet. In such a system, the remote and dongle pairing may obtain controlled access to one or more streaming channels over the internet via a director. The remote and dongle communicate with a local PC (which may be part of a set-top box or an audio and/or video device such as a cell phone, television set, actual physical computer, etc.), which sends an initiation signal via the internet to a director (a secure connection server) that controls access to one or more streaming channels. The director responds to the initiation signal with a query signal. The query signal is passed, via the internet and local PC, back to the dongle. The dongle responds to the query signal with an answer, which may be encrypted and may include an identification code (which identifies the particular dongle) and/or an additional password. When the director receives the answer, it determines if the particular dongle is authorized to access the requested streaming content.

In determining whether a particular dongle is authorized for access, the director may check a billing database to ensure that the dongle's owner has paid up the appropriate account(s). The director may also check to ensure that the particular dongle identification and/or password are not being used by more than one user at the same time. If the director detects more than one user accessing (or attempting to access) online content using the same identification and/or password, the director can block the latest attempted access and/or shut down existing access to all users that are using the particular identification and/or password.

Once the director has cleared the dongle identification and/or password, the director grants access to the requested streaming content, which is transmitted to the intermediary PC via the internet. This streaming content may also be encrypted specifically for that dongle identification and/or password, and the dongle's processor(s) can use the dongle's own internal private key to decrypt that streaming content.

The portable wireless remote and receiver pair can communicate with each other wirelessly, such as via infrared (IR) protocols. In another embodiment the portable wireless remote and receiver pair can communicate via radio-frequency (RF) protocols. This serves the same purpose as IR and can allow the device to work more freely than with infrared controls, which are by nature more directional in operation.

In another embodiment of the present invention, the remote and dongle pairing, or the control and dongle, may be combined and can be used to control the streaming data and content on a cell phone such as a Windows Mobile, Palm OS, Symbian OS (or equivalent) based cell phone.

In a further embodiment of the present invention, the dongle and accompanying software could operate from an intermediary PC contained in a control box that controls and/or processes internet-based content that is then passed on to an audio and/or video device. The control box could be a standard set-top box (similar to those used for accessing cable television programs), with the remote used to control dongle and set-top box operation. The dongle could be removably plugged into a port on the set-top box, or could be imbedded into the set-top box.

In another embodiment of the present invention, the intermediary PC is contained within a television set, the dongle is connected or incorporated into the television set, and the remote is used to control television and dongle operation. The dongle could be removably plugged into a port on the television, or could be imbedded into the television.

In another embodiment of the invention, the device can be applied to cell phones and similar devices providing wireless communications. In cell phones that have Windows Mobile (or equivalent) as their OS, it can be awkward and time consuming to require the user to enter a name and password combination each time to be used. The wireless remote and USB dongle can be paired and used on the cell phone type device wherein the user has a high speed internet data connection like EVDO, GPRS or 3G to be able to uniquely identify the subscriber and control the content. In this embodiment, it would be more likely to use RF communication between the remote and the dongle, rather than IR communications. A typical expression of this invention could also include the operational interface software to be installed on the cell phone to maintain communication security by monitoring public/private encryption key and identification continuity during control operation.

In yet another embodiment in conjunction with cell phones, it is desirable to contain the entire dongle package and control into one unit that attaches to the cell phone rather than having a separate remote and dongle combination.

Other objects, features, and advantages of the present invention will become apparent from a consideration of the following detailed description.

### BRIEF DESCRIPTION OF THE DRAWINGS

FIG. 1 is a block diagram of the external remote control pair according to an embodiment of the present invention;

FIG. 2A is a block diagram of an external remote control accessory pair being used with a cell phone according to an embodiment of the present invention;

FIG. 2B is a block diagram of an external remote control accessory pair being used with a cell phone according to a further embodiment of the present invention;

FIG. 3A is a block diagram of a user-side system according to an embodiment of the invention, wherein the dongle is removably connected to a set-top box;

FIG. 3B is a block diagram of a user-side system according to an embodiment of the invention, wherein the dongle is incorporated into a set-top box;

FIG. 4A is a block diagram of a user-side system according to an embodiment of the invention, wherein the dongle is removably connected to a television set;

FIG. 4B is a block diagram of a user-side system according to an embodiment of the invention, wherein the dongle is incorporated into a television set; and

FIG. 5 is a block diagram of a system according to an embodiment of the invention.

### DETAILED DESCRIPTION

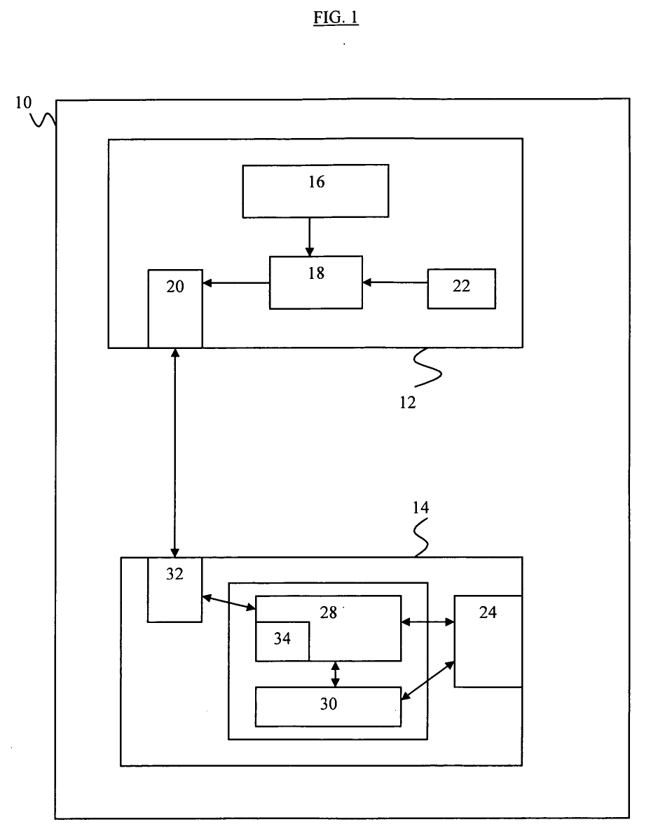

In the embodiment depicted in FIG. 1, the invention includes a linked pair 10 including a wireless remote control 12 and a dongle 14. The remote control 12 includes a keyboard 16 having one or more buttons to control functions such as program and/or game selection and operation, volume, etc. The remote control 12 also includes a processing core 18, a wireless communication unit 20, and a power source 22. The processing core 18 can be almost any type of microprocessor unit. The wireless communication unit 20 may use any type of wireless communication methods, such as infrared and/or radiofrequency wireless communications, depending on the particular application. The power source 22 can be a battery, such as a rechargeable battery.

The linked pair 10 also includes a dongle 14. The dongle 14 includes a communication port 24, a dongle processor 26 comprising one or more dongle control processors 28 and one or more numeric processors 30, and a communication unit 32. Note that the dongle processor 26 could have just a dongle control processor 28, or just a numeric (security) processor 30, depending on the particular embodiment.

The communication port 24, which in the particular embodiment depicted is a USB port, is configured to be connected to an intermediary PC to provide communications therewith. The intermediary PC may be a set-top box, television, cell phone, or standard personal computer. In addition to communications, the dongle 14 can also receive power through the communication port 24.

The dongle 14 includes at least one memory 34, which in the embodiment depicted is a part of the dongle control processor 28, such as an internal flash memory. The memory 34 is programmed to hold an identification code and/or password. The identification code identifies the particular dongle 14. Depending on the particular embodiment, the identification code and/or password can be preprogrammed into the memory 34 during production of the dongle 14, during the sale of the dongle 14 (e.g., at the point of purchase), or at another time such as during interaction between the dongle 14 and an internet-based director over an internet connection. In one embodiment, an identification code is preprogrammed into the dongle 14 during production, and the password is programmed into the dongle 14 at the point of sale or during use of the dongle.

The dongle communication unit 32 is configured to communicate with the remote control 12 via the remote control wireless communication unit 20. The dongle communication unit 32 may use any type of wireless communication methods, such as infrared and/or radio frequency wireless communication methods, depending on various factors such as the particular application, including the type of wireless communication methods used by the remote control 12.

The dongle processor 26, and more particular in the embodiment of FIG. 1 the dongle control processor 28, controls and reads data as requested by the intermediary PC in an encrypted protocol familiar to those who are skilled in the art. The dongle processor 26, and more particular in the embodiment of FIG. 1 the one or more dongle numeric processors 30, are configured to read and decipher the signals received from the remote control 12, so that selections received from the remote control 12 can be communicated to the intermediary PC via the communication port 24. Depending on the particular application, the dongle processor 26 may be configured to perform real-time decryption of one or more multimedia streams, using the dongle identification and/or password and/or an internal dongle decryption key.

The remote control 12 can be preprogrammed during production, and/or be programmable at the point of sale and/or by the user. Depending on the particular application, the remote control 12 may include a memory that can remember channels and/or programs selected by the user, etc. The remote control 12 may also include a timer/alarm to automatically send a shut-off signal (via the dongle 14) to shut off a television set or other audio and/or video device at designated time or after designated period (e.g., in 15 minutes). The timer/alarm feature could also permit the remote control to automatically send a turn-on and/or program/channel selection signal via the dongle 14 to automatically turn an audio and/or video device on and/or to specific channel/program. The remote control 12 could provide a password/identification key to the dongle 14, so that a particular dongle 14 would only operate in response to a remote 12 having the appropriate password/identification.

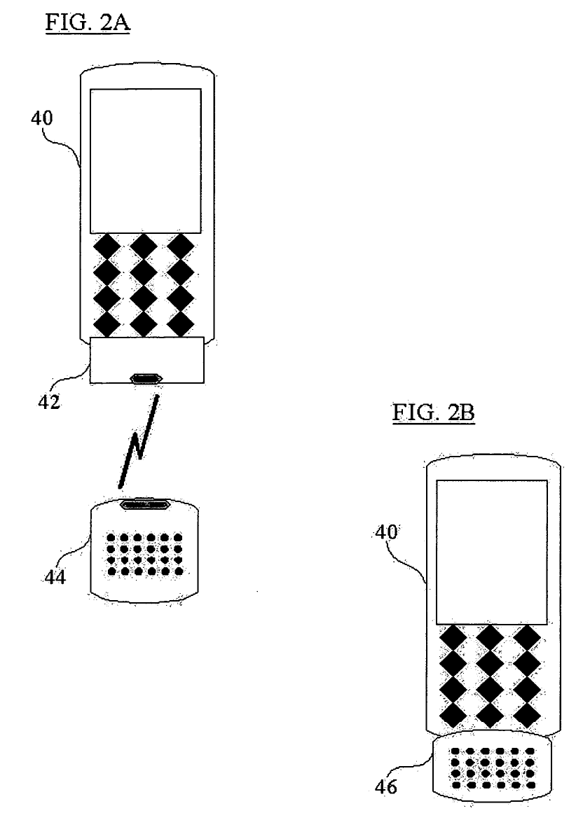

As shown in FIGS. 2A and 2B, a linked pair such as that depicted in FIG. 1 can be used to interface to a cell phone device 40. In FIG. 2A, a separate pairing of a dongle 42 and remote control 44 provide the interface, with the dongle 42 connected via a port (such as a USB port) of the cell phone device 40. As in the embodiment of FIG. 1, the remote control 44 and dongle 42 communicate with each other via wireless communications.

In the embodiment of FIG. 2B, a remote control portion and dongle portion are combined and/or connected directly together into a combined pair 46, and the combined pair 46 is connected directly to the cell phone device 40. In this embodiment, direct (as opposed to wireless) communications between the remote control portion and dongle portion can be used.

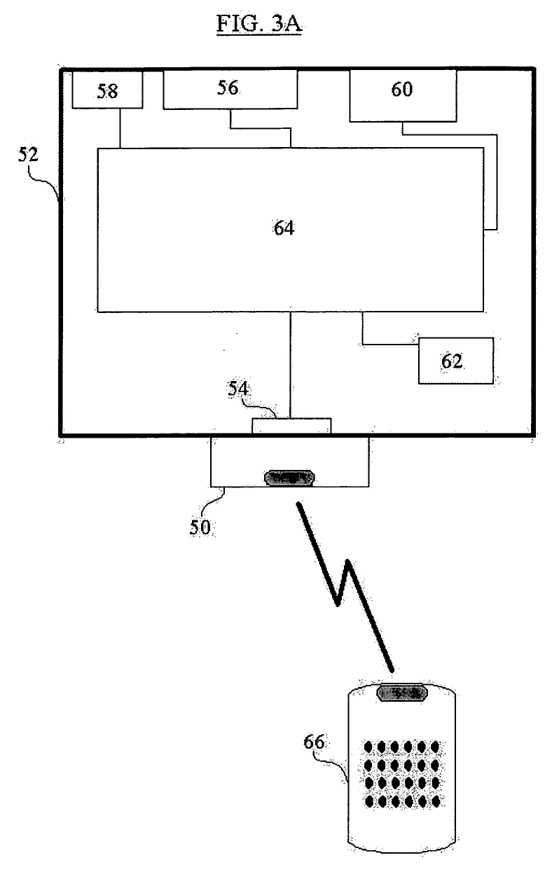

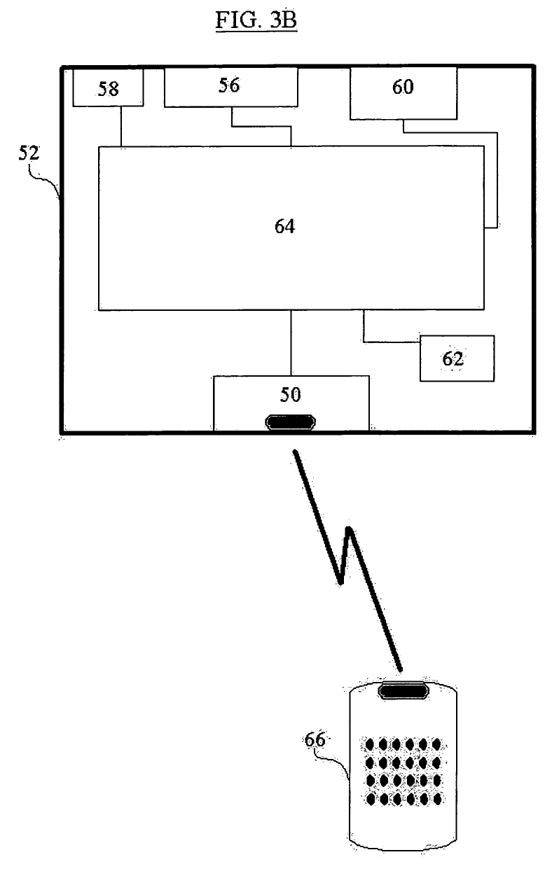

In the embodiment of FIG. 3A, a dongle portion 50 is shown connected to an intermediary PC in the form of a set-top cable box 52. In typical fashion many of these set-top cable boxes are actually either Windows- or Linux-based personal computers. They typically have relatively smaller motherboard units, but still have the standard port interfaces, such as one or more USB ports, internet connection ports and/or wireless internet connection, co-axial cable ports, etc. In the particular embodiment of FIG. 3, the set-top cable box 52 includes a USB port 54, an internet connection in the form of an internet connection port 56, and a connection port 58 for transmitting program content an audio and/or video device connection port. The particular set-top cable box 52 also includes a power source 60 (typically a power plug providing power from the local electrical grid), a hard drive 62, and a processor 64. The set-top cable box 52 accesses the internet via the internet connection port 56. Note that the internet connection may be via a wireless internet connection and/or via a physical port connection. The dongle portion 50 is connected to the set-top cable box 52 via the USB port 54. To access desired programming, the user can connect the dongle portion 50 to the set-top cable box 52, and then use the paired remote 64 to select the desired programming.

Alternatively, as in FIG. 3B, the dongle portion 50 could be incorporated within the set-top box 52 itself. In such an embodiment, the dongle portion 50 is not easily removable, and its identification code will thus serve to identify not just the dongle 50 but also the particular set-top box 52. The set-top box could be small enough to be completely portable, so that a user could take a personal set-top box along on travels, etc., and connect the set-top box to an internet connection and to any available television set or other audio and/or video device.

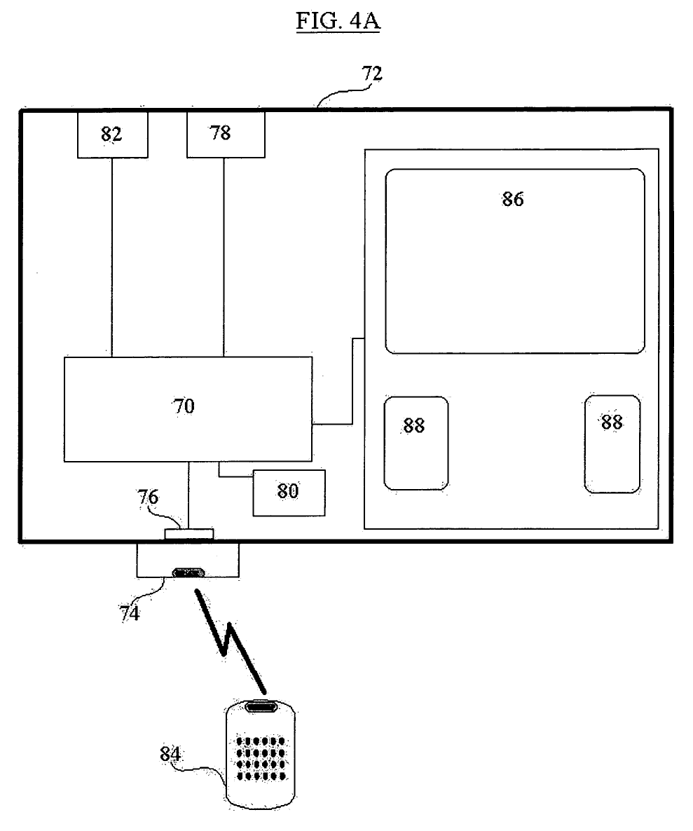

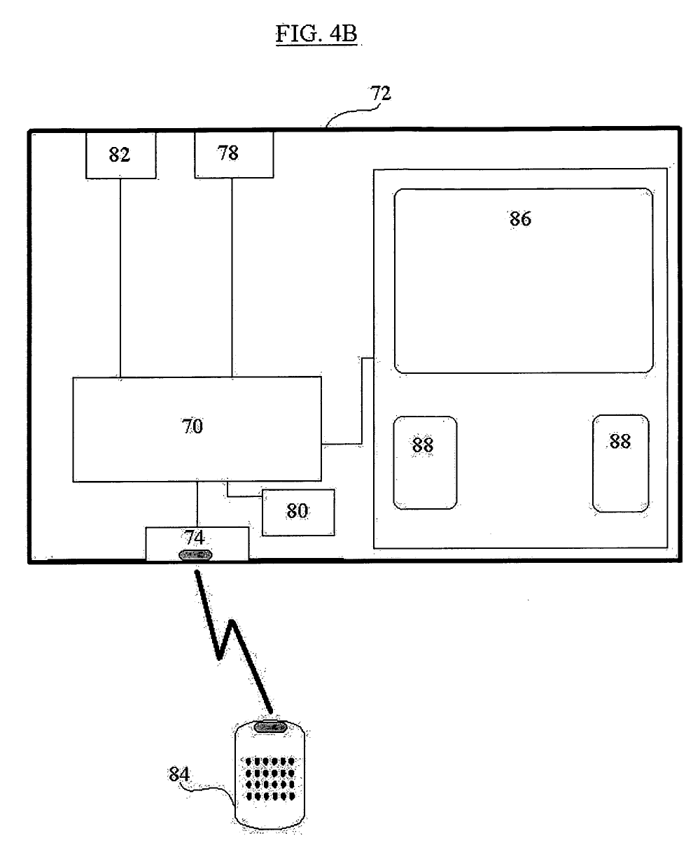

As shown in FIG. 4A, an intermediary PC 70 (configured with other elements to provide the same functions as a set-top box) can be incorporated directly into an audio and/or video display device, which in the embodiment of FIG. 4A is a television set 72. The dongle 74 is removably secured to the television set 72 via a port 76, such as a USB port. The particular television set 72 includes a power source 78 (typically a conventional electrical plug providing power from the local electrical grid), and a hard drive 80 which is connected to and/or part of the intermediary PC 70. The intermediary PC 70 accesses the internet via an internet connection port 82. Note that a wireless internet connection is also within the scope of the invention. To access desired programming, the user can connect the dongle portion 74 to the television set 72, and then use the paired remote 84 to select the desired programming. Once the desired programming is received and/or decrypted, it can be relayed to the television screen 86 and television speaker(s) 88.

Alternatively, as in FIG. 4B, the dongle portion 74 could be incorporated within the television set 72 itself. In such an embodiment, the dongle portion 74 is not easily removable, and its identification code will thus serve to identify not just the dongle 74 but also the particular television set 72.

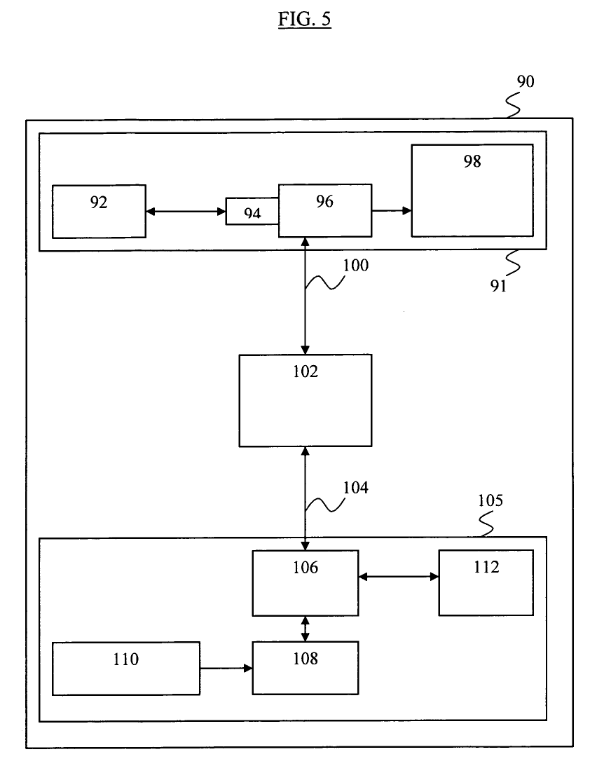

FIG. 5 depicts a system 90 according an embodiment of the invention, including the logical operation and interaction of the various system elements. On the user end is a user-side assembly 91 or system, which includes a remote control 92, a dongle 94, an intermediary PC 96, and a television set 98 or other audio and/or visual device. The intermediary PC 96 is connected via an ISP or similar internet connection 100 to the internet 102. On the provider or host end, connected to the internet 102 via an ISP or similar internet connection 104, is a host-side assembly 105 or system including a director 106, head 108, and streaming channel source 110. Depending on the particular embodiment, there may also be an access approval database, such as a billing system database 112.

When a user desires to access streaming content via the system 90, he or she will activate the intermediary PC 96 via the remote control 92 and dongle 94. The dongle 94 passes the commands from the remote control 92 to the intermediary PC 96. The intermediary PC 96 includes an executable PC program which will provide a query that the intermediary PC 96 will send back to the dongle 94. The query may include a specific question and/or password that will prompt the dongle 94 to provide an answer.

The dongle 94 includes a secure memory system that holds the dongle identification and/or password. The secure memory system may hold the dongle identification and/or password in an encrypted and/or unreadable form. In one embodiment, the dongle 94 will provide the dongle identification and/or password only in response to a specific and correct question and/or password from the intermediary PC. In other words, the only way in which the dongle 94 can respond to an intermediary PC 96 (via the executable PC program), or to any other request for a response (such as from a potential system hacker), is if the dongle 94 has been properly queried with a correct question and/or password.

If the dongle response is correct, then the intermediary PC 96 will pass the dongle identification and/or password or encrypted certificate information to the director 106. The query from the intermediary PC 96 will be responded to by the dongle 94 (and more specifically by a security enumerator portion of the dongle, if the dongle is so equipped). The response may be in the form of an encrypted response including the dongle identification and/or password and/or encrypted certificate. Once the dongle 94 responds to the intermediary PC with the dongle identification and/or password, the intermediary PC 96 determines if all, or at least a portion, of the identification and/or password is a correct response. If the dongle response is incorrect, the execution is stopped and the intermediary PC 96 will not send the commands/requests to the director 106 via the internet 102. If and only if the intermediary PC 96 receives a correct response from the dongle 94, the intermediary PC 96 will transmit, via the internet 102, a request for access to the director 106. The request for access will include and/or be accompanied by the dongle identification and/or password. The request for access sent to the director 106 may be accompanied by information in addition to the dongle identification and password, such as specific content request information provided by the user via the remote.

When the director 106 receives the request for access, the director 106 will determine if the dongle identification and/or password are valid, as well as determining what types of streaming content the dongle is authorized to access. As part of this access determination, the director 106 may consult with one or more access approval databases. In the embodiment of FIG. 5, the director 106 consults with a billing system database 112 to ensure that the account associated with the dongle 94 is current and/or paid up.

Once the director 106 determines that a dongle identification and/or password are valid and that the dongle 94 is authorized to access the requested streaming content, the director 106 will provide access to the streaming channel source 110, which transmits the requested content to the intermediary PC 96 via the internet 102. The requested content is then presented to the user via the television set 98 or other audio and/or visual device.

The director 106 may also be configured to make sure that a particular dongle identification and/or password is not being used by more than one party at the same time. For example, if the director 106 detects more than one access attempts using the same identification and/or password, the director may be configured to shut down access to the streaming content from all users whose access is based on the particular dongle identification and/or password.

The dongle could have internal memory configured to keep track of the user's favorite programs, etc. The dongle may also have sufficient processing power, along with a private key code and/or other internal decryption information, to decrypt the streaming multimedia data internally (i.e., within the dongle), so that no decryption key and/or other confidential decryption information is ever passed from the director to the local user's system (other than to the dongle itself). This feature can prevent an unauthorized party from accessing confidential decryption information from other system elements, such as a local set-top box from which the dongle is removably attached, etc.

The dongle could be programmed, during production or at the point of sale, to permit a certain value of programming to be accessed via the dongle, with further program access being discontinued when the set value was met and/or exceeded (similar to a pre-paid phone card). In one such embodiment, the dongle itself may include the internal memory and processor configured to keep track of the amount of programming authorized, the amount of programming used, etc. Such a dongle could automatically cease to request programming when the authorized value was exceeded, and/or could send a shut-off signal to the director so that the director would know to prevent any further media access requested by the identification code of the particular dongle. The dongle could alternatively be configured so that the dongle authentication code itself indicated the set value, with the director having access to a database that correlated the dongle authentication code with the set (pre-authorized) value of the programming the particular dongle is permitted to access. In such an embodiment, the director could keep track of the programming accessed by the dongle and, upon the set value being met and/or exceeded, cease supplying further content to the dongle. The director could also send a decommissioning signal to the dongle when the set value was met and/or exceeded, so that the particular dongle would reconfigure itself (e.g., disable itself) so that it would not make any further media requests from the director.

A dongle could have a memory configured to keep track of information relating to the programs accessed, including program identification, program value, etc. For example, a hotel could provide a dongle to a guest upon check-in. With a dongle configured to keep track of the value and/or other program information, the dongle could be returned to the front desk by the guest, the program memory accessed, and the guest billed accordingly.

A dongle could also be programmed to permit access to only specific types of material. For example, a dongle could be programmed to permit access only to child-appropriate programming, or to permit access to programming up to that approved for teenagers, or to permit access to adult-content programming, etc. In this way, a parent could have a “child-appropriate” dongle on an audio and/or visual device (such as a television set, computer, or video game controller) when children are present, and then switch to an “adult” authorized dongle when the children are no longer present. Each child and/or other individual that might be present in a particular a household could have his or her own dongle, with appropriate programming limits included in each dongle that are appropriate to the particular user of the dongle. In this way, a teenager may have additional programming access over that allowed for a younger child, whereas an adult might have access to all content. In this way, everyone could make use of the same television sets or other audio and/or video system throughout the house, but each user would only be able to access appropriate programming.

While the invention has been described with reference to particular embodiments, it will be understood that various changes and additional variations may be made and equivalents may be substituted for elements thereof without departing from the scope of the invention or the inventive concept thereof. In addition, many modifications may be made to adapt a particular situation or device to the teachings of the invention without departing from the essential scope thereof. Therefore, it is intended that the invention not be limited to the particular embodiments disclosed herein, but that the invention will include all embodiments falling within the scope of the appended claims.

What is claimed is:

1. A user-side assembly for providing an access code to a remote director, the remote director providing access to streaming media, the user-side assembly comprising:
a remote control configured to transmit wireless control signals, wherein the remote control comprises a keyboard configured to receive input from a user;
a dongle, wherein the dongle comprises:
a wireless remote control communications receiver configured to receive wireless control signals from the remote control;
a dongle memory containing an access code;
a dongle processor configured to provide the access code in response to an appropriate access code request; and
an intermediary communication port configured to transmit the identification code to the remote director and to receive queries from the remote director.

2. The user-side assembly of claim 1, wherein the dongle memory contains a decryption key, and the dongle processor is configured to decrypt encrypted streaming content using the decryption key.

3. The user-side assembly of claim 1, further comprising:
an intermediary computer, the intermediary computer having a communication port configured to connect to the dongle intermediary communication port, wherein the intermediary computer is configured to provide the appropriate access code request to the dongle processor.

4. The user-side assembly of claim 3, wherein the intermediary computer comprises an internet connection, and wherein the dongle intermediary communication port is configured to transmit the identification code to the remote director via the intermediary computer and internet connection, and to receive queries from the remote director via the intermediary computer and internet connection.

5. The user-side assembly of claim 3, wherein the dongle memory contains a decryption key, the dongle processor is configured to provide the decryption key to the intermediary computer, and the intermediary computer is configured to decrypt encrypted streaming content using the decryption key.

6. The user-side apparatus of claim 3, wherein the intermediary computer comprises a memory configured to store streaming content for later retrieval.

7. The user-side apparatus of claim 1, wherein intermediary connection port comprises a USB port.

8. An apparatus for providing an access code to a remote director controlling media content via an internet-like connection, the apparatus comprising:
a docking port, the docking port configured to removably connect the apparatus to a computer, the docking port configured to provide a communication link between the apparatus and computer, and to transmit power from the computer to the apparatus;
a memory containing an access code specific to the particular apparatus;
a processor, the processor configured to transmit the access code to the remote director via the docking port; and
a wireless receiver configured to receive control signals via wireless transmission from a remote control device.

9. The apparatus of claim 8, wherein the docking port is a USB port.

10. The apparatus of claim 8, wherein the memory contains at least a portion of the access code in a secure format, wherein the portion of the access code in a secure format is transmitted by the processor only in response to an appropriate query.

11. The apparatus of claim 8, wherein the access code comprises an identification code and a password.

12. The apparatus of claim 11, wherein the identification code is contained in a permanent portion of the memory.

13. The apparatus of claim 8, wherein the memory contains a decryption key.

14. The apparatus of claim 12, wherein the processor is configured to decrypt encrypted streaming media content using the decryption key.

15. A system for providing media content from a host-side assembly to at least one user-side assembly via an internet-like connection which connects the host-side assembly to the user-side assembly,
wherein the host-side assembly comprises:
a source of media content;
a director configured to control access to the source of media content, wherein the director is configured to provide access only in response to an appropriate identification;
and wherein the at least one user-side assembly comprises:
an audio and/or video device configured to present the streaming media content in a desired form.
a remote control configured to transmit control signals, wherein the remote control comprises a keyboard configured to receive input from a user; and
a dongle, wherein the dongle comprises:
a remote control communications receiver configured to receive control signals from the remote control;
a dongle memory containing an identification code; and
a dongle processor configured to provide the access code in response to an appropriate query.

16. The system of claim 15, wherein the user-side assembly further comprises:
an intermediary computer, the intermediary computer comprising a processor configured to provide the appropriate query to the dongle processor.

17. The system of claim 16, wherein the dongle memory comprises a decryption key, the dongle processor is configured to provide the decryption key to the intermediary computer, and the intermediary computer is configured to decrypt encrypted streaming media content using the decryption key.

18. The system of claim 15, wherein the dongle memory comprises a decryption key.

19. The system of claim 17, wherein the dongle processor is configured to decrypt encrypted streaming media content using the decryption key.

20. A method, apparatus, kit, or system for providing media content to a user and/or providing an access code to a remote director, substantially as shown and described in this application.
